(19) United States
(12) Patent Application Publication
(10) Pub. No.: US 2014/0214185 A1
(43) Pub. Date: Jul. 31, 2014

(54) Somatosensory Household Electricity Control Equipment and System Thereof

(71) Applicant: Kuo-Chung HUANG, Taipei City (TW)

(72) Inventor: Kuo-Chung HUANG, Taipei City (TW)

(21) Appl. No.: 13/749,997

(22) Filed: Jan. 25, 2013

(51) Int. Cl. G05B 15/02

(52) U.S. Cl. CPC G05B 15/02
USPC 700/83

(57) ABSTRACT

A somatosensory household electricity control equipment and a system thereof is used in an indoor space in which a household electricity equipment is fixed. The household electricity equipment contains: a host device fixed in the indoor space; at least one action identifying device for receiving image data of the posture motion connected with the host device; a signal receiving module fixed in household electricity products and receiving a signal transmitted from the host device; and an external configuration interface used to connect with the host device so as to edit and correct data.

### BACKGROUND OF THE INVENTION

1. Field of the Invention

The present invention relates to a somatosensory household electricity control equipment and a system thereof by using a somatosensory identification technology to check user's actions and gestures preset in database and transmits a remote control signal, thus operating the somatosensory household electricity control equipment and the system thereof.

2. Description of the Prior Art

A conventional appliance automation system has a contact—visual interface so as to operate and receive an operation feedback. However, this conventional contact—visual interface will limit operation range. i.e., the user operates such a conventional appliance automation system inconveniently. Besides, the user has to operate the appliance automation system by using a visual interface and by viewing target object. However, a cognitive dissonance generates between manipulation target and visual feedback, thus having a wrong operation.

Accordingly, an untouched intuition control method has to be developed so that the user confirms operational instruction without changing sight and to avoid actual device. In addition, this intuition control method will replace buttons and switches.

The present invention has arisen to mitigate and/or obviate the afore-described disadvantages.

### SUMMARY OF THE INVENTION

The primary object of the present invention is to provide a somatosensory household electricity control equipment and a system thereof which is capable of controlling household electrical products by using user's actions and gestures, so an additional hardware device for inputting instruction and having visual feedback is unnecessary.

A somatosensory household electricity control equipment and a system thereof in accordance with a preferred embodiment of the present invention being used in an indoor space in which a household electricity equipment is fixed, the household electricity equipment contains:

a host device fixed in the indoor space;

at least one action identifying device for receiving image data of the posture motion connected with the host device;

a signal receiving module fixed in household electricity products and receiving a signal transmitted from the host device;

an external configuration interface used to connect with the host device so as to edit and correct data.

In one embodiment, the host device includes a target determining module for receiving image data transmitted from the at least one action identifying device so as to determine a targeted household electricity product; a mode identification module for receiving image data transmitted from the at least one action identifying device so as to determine if the image data complies with a control command preset by the at least household electrical product; and a household electricity product control module for transmitting the control command to the signal receiving module.

In one embodiment, the action identifying device includes a detection camera for receiving image data and a data transmission module for transmitting the image data to the target determining module and the mode identification module of the host device so as to integrate and analyze the image data.

In one embodiment, the image data are distance depths and color images.

In one embodiment, the household electricity products further includes a signal receiving module for receiving a signal and turning on or off and adjusting the household electrical product.

In one embodiment, the external configuration interface includes a household electrical product positioning interface for displaying a detecting area of the household electrical product and an identification code corresponding to the detecting area and a movement control configuration interface for correcting a corresponding relationship and editing a motion control mode of the household electrical product.

In one embodiment, the household electrical products are selected from household appliances, electric curtains, and lamps.

In addition, a somatosensory household electricity control equipment and a system thereof being used in an indoor space in which a household electricity equipment is fixed, the system contains steps of:

(a) starting a host device;

(b) inputting user's posture motion;

(c) determining if an operation instruction is identified or not;

(d) identifying actions and positioning a targeted household electricity product;

(e) determining if the targeted household electricity product is positioned or not;

(f) transmitting a signal to the targeted household electricity product; and

(g) finishing an operation of the targeted household electricity product.

In one embodiment, the step (b) includes capturing image data from an action identifying device.

In one embodiment, in the step (c) to (f), the host device starts an analyzing process.

### BRIEF DESCRIPTION OF THE DRAWINGS

FIG. 1 is a block diagram of a somatosensory household electricity control equipment and a system thereof in accordance with a preferred embodiment of the present invention.

FIG. 2 is a flow chart of a somatosensory household electricity control equipment and a system thereof in accordance with a preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

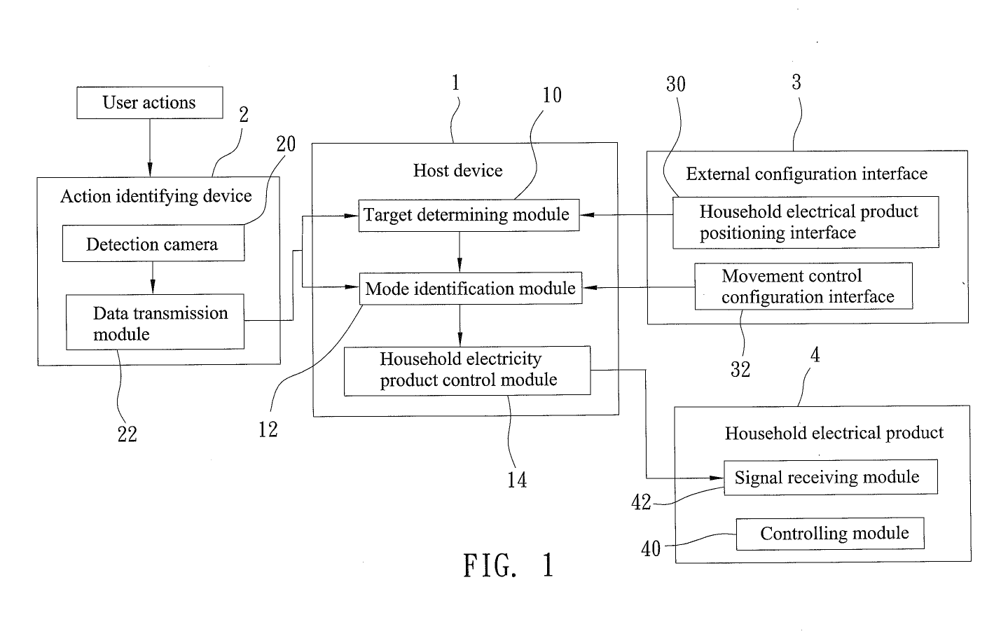

Referring to FIG. 1, a somatosensory household electricity control equipment and a system thereof according to a preferred embodiment of the present invention is used in an indoor space in which a household electricity equipment is fixed, the household electricity equipment is comprised of a host device 1, at least one action identifying device 2, an external configuration interface 3, and a household electrical product 4, wherein the host device 1 includes a target determining module 10, a mode identification module 12, and a household electricity product control module 14; the action identifying device 2 includes a detection camera 20 and a data transmission module 22, and the detection camera 20 is used to acquire image data (such as distance depths and color images) as a user is in a detected space, the data transmission module 22 transmits the image data to the target determining module 10 and the mode identification module 12 of the host device 1 so as to integrate and analyze the image data. As the target determining module 10 is in an analyzing process, a directional vector which represents user's actions and gestures is captured so as to determine the household electrical product 4 which the user is desired to control, and then codes of the household electrical product 4 (such as household appliances, electric curtains or lamps) are numbered (such as setting the codes of #1, #2, #3 etc.) and transmitted to the mode identification module 12.

In the meantime, the mode identification module 12 receives the image data from the data transmission module 22 and transforms the user's actions and the gestures into a parameterized model identification, and then the codes of the household electrical product 4 transmitted by the target determining module 10 are inquired and compared with a corresponding table of operation mode—household electrical products control command which is preset by the external configuration interface 3, such that the user's actions and gestures are determined if they match with a control command preset by the household electrical product 4, and the control command is transmitted to a controlling module 40 of the household electrical product 4 so as to further transmit a wireless signal to a signal receiving module 42 of the household electrical product 4. In addition, the signal receiving module 42 receives a control command transmitted by the host device 1 via the wireless signal so that the household electrical product 4 is turned on or off and is adjusted. Thereby, the user is capable of controlling the household electricity product system by ways of his/her actions and gestures in a living environment, so an additional hardware device for inputting instruction and having visual feedback is unnecessary.

The external configuration interface 3 includes a household electrical product positioning interface 30 and a movement control configuration interface 32 for facilitating the user's interface by using pattern configurations. After the household electrical product positioning interface 30 is connected with the host device 1, the user marks a detecting area of the household electrical product 4 on a menu and an identification code corresponding to the detecting area (such as a represented code 5 denoting a kitchen area, and an original code 5 representing a refrigerator). The movement control configuration interface 32 is a listed table of the user's actions and gestures corresponding to control functions of the household electrical product so that the user corrects and edits by correcting a corresponding relationship and editing a motion control mode of the household electrical product.

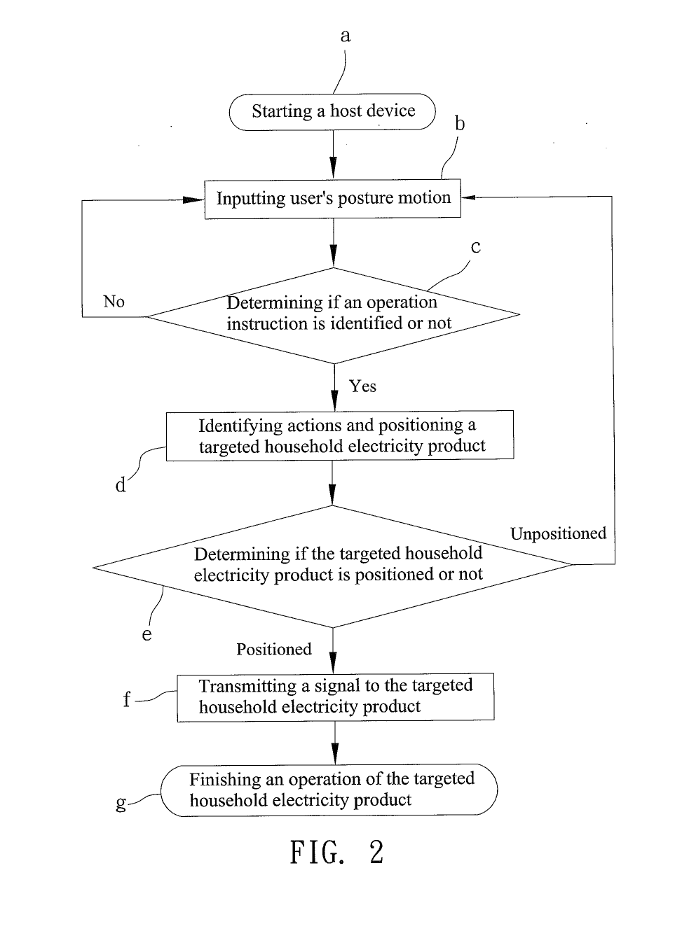

As shown in FIG. 2, an operation process of the somatosensory household electricity control equipment includes steps of:

(a) starting a host device;

(b) inputting user's posture motion;

(c) determining if an operation instruction is identified or not;

(d) identifying actions and positioning a targeted household electricity product;

(e) determining if the targeted household electricity product is positioned or not;

(f) transmitting a signal to the targeted household electricity product; and

(g) finishing an operation of the targeted household electricity product.

After processing the step of inputting user's posture motion (b), the user's posture motion is identified in the step (c). If an input is right, the step (d) is processed, i.e., identifying actions and positioning the targeted household electricity product. If the input is not right, the user has to make posture motion again until the posture motion is identified. Thereafter, the targeted household electricity product is positioned in the step (d), i.e., the target determining module 10 (as illustrated in FIG. 1) so as to determine a position of the targeted household electricity product. If the target determining module 10 is positioned, in the step (f), a signal is transmitted to the targeted household electricity product, thus finishing the step (g). If the step (e) is failed, the operation process returns back to the step (b) so that the user redefines the posture motion until the posture motion is identified. As shown in FIG. 1, in the step (b), the action identifying device 2 captures image data of the posture motion, and in the step (c) to (f), the host device 1 starts an analyzing process.

While we have shown and described various embodiments in accordance with the present invention, it is clear to those skilled in the art that further embodiments may be made without departing from the scope of the present invention.

What is claimed is:

1. A somatosensory household electricity control equipment and a system thereof being used in an indoor space in which a household electricity equipment is fixed, the household electricity equipment comprising:
a host device fixed in the indoor space;
at least one action identifying device for receiving image data of the posture motion connected with the host device;
a signal receiving module fixed in household electricity products and receiving a signal transmitted from the host device;
an external configuration interface used to connect with the host device so as to edit and correct data.

2. The somatosensory household electricity control equipment and the system thereof as claimed in claim 1, wherein the host device includes a target determining module for receiving image data transmitted from the at least one action identifying device so as to determine a targeted household electricity product; a mode identification module for receiving image data transmitted from the at least one action identifying device so as to determine if the image data complies with a control command preset by the at least household electrical product; and a household electricity product control module for transmitting the control command to the signal receiving module.

3. The somatosensory household electricity control equipment and the system thereof as claimed in claim 2, wherein the action identifying device includes a detection camera for receiving image data and a data transmission module for transmitting the image data to the target determining module and the mode identification module of the host device so as to integrate and analyze the image data.

4. The somatosensory household electricity control equipment and the system thereof as claimed in claim 3, wherein the image data are distance depths and color images.

5. The somatosensory household electricity control equipment and the system thereof as claimed in claim 1, wherein the household electricity products further includes a signal receiving module for receiving a signal and turning on or off and adjusting the household electrical product.

6. The somatosensory household electricity control equipment and the system thereof as claimed in claim 1, wherein the external configuration interface includes a household electrical product positioning interface for displaying a detecting area of the household electrical product and an identification code corresponding to the detecting area and a movement control configuration interface for correcting a corresponding relationship and editing a motion control mode of the household electrical product.

7. The somatosensory household electricity control equipment and the system thereof as claimed in claim 1, wherein the household electrical products are selected from household appliances, electric curtains, and lamps.

8. A somatosensory household electricity control equipment and a system thereof being used in an indoor space in which a household electricity equipment is fixed, the system comprising steps of:
(a) starting a host device;
(b) inputting user's posture motion;
(c) determining if an operation instruction is identified or not;
(d) identifying actions and positioning a targeted household electricity product;
(e) determining if the targeted household electricity product is positioned or not;
(f) transmitting a signal to the targeted household electricity product; and
(g) finishing an operation of the targeted household electricity product.

8. The somatosensory household electricity control equipment and the system thereof as claimed in claim 8, wherein the step (b) includes capturing image data from an action identifying device.

9. The somatosensory household electricity control equipment and the system thereof as claimed in claim 8, wherein in the step (c) to (f), the host device starts an analyzing process.
